(19) United States
(12) Patent Application Publication
(10) Pub. No.: US 2007/0205136 A1
(43) Pub. Date: Sep. 6, 2007

(54) Method of Packaging Safety and Rescue Equipment and a Package for Packaging Safety and Rescue Equipment and use of the Method and the Package

(75) Inventor: Erik R. Jacobsen, Malmo (SE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: RESQ A/S, Greve (DK)

(21) Appl. No.: 11/632,728

(22) PCT Filed: Jul. 18, 2005
(86) PCT No.: PCT/DK05/00499

§ 371 Date: Mar. 8, 2007

(30) Foreign Application Priority Data
Jul. 21, 2004 (DK) PA 2004 01134

(51) Int. Cl. A61J 1/00; A61J 1/18

(52) U.S. Cl. 206/803; 206/459.1; 206/497

(57) ABSTRACT

A method of packaging safety and rescue equipment (1) as well as a package for packaging it, formed by a light-impermeable vacuum package, in whose surface an inspection window (13) is optionally provided as well as a moisture indicator (14) behind this inspection window and a drying means inside the package. The safety and rescue equipment is used in tall structures in particular, such as in windmills, on drilling platforms and in antenna masts. According to the invention, the safety and rescue equipment is protected against the weather, UV light and mechanical impacts that may occur between the line of the safety and rescue equipment and the metal parts to which the line is secured, which means that it is just necessary to inspect it in intervals of about 6 years as against normally 1 year.

The invention relates to a method of packaging safety and rescue equipment.

Moreover, the invention relates to a package for packaging safety and rescue equipment.

Finally, the invention relates to use of the method and the package.

In connection with tall structures, such as windmills, drilling platforms, multi-storey buildings, towers, bridges and antennas, it is required that safety and rescue equipment is permanently placed in the tall structure. Such rescue and safety equipment consists of a line connected to a lowering mechanism, so that persons can get down from the tall structure in case of accident, fire, disease, etc. Normally, the safety and rescue equipment is disposed in a bag which is disposed in a box of metal or plastics.

Clearly, such rescue and safety equipment must be inspected regularly, thereby ensuring that it functions and is safe when it is to be used. Normally, it is required that safety and rescue equipment is inspected once a year.

Such inspection is quite time-consuming, and it is required that it is performed by skilled staff, which means of course that the inspection is rather costly.

Typically, there are two reasons why damage to safety and rescue equipment may occur. One reason may be the weather, where e.g. etching may occur on the equipment, if it is placed in the vicinity of salt water, which is the case with windmills and drilling platforms.

Another reason may be purely mechanical wear of the actual safety and rescue equipment, as the mechanical impacts, which occur when the tall structure moves, cause e.g. the line of the safety and rescue equipment to be damaged by the metal parts to which the line is secured, since a movement takes place between the line and the metal parts.

Accordingly, an object of the invention is to secure safety and rescue equipment such that the intervals between the inspections may be increased considerably, e.g. from 1 to 6 years.

The object of the invention is achieved by a method of the type defined in the introductory portion of claim 1, which is characterized in that the safety and rescue equipment is packaged in a vacuum package which is impermeable to light.

Hereby, the safety and rescue equipment is shielded from the impacts of the surrounding environment.

It is moreover ensured that the individual parts of the equipment do not affect each other, thereby avoiding mechanical wear.

As mentioned, the invention also relates to a package, which is of the type defined in the introductory portion of claim 2. This package is characterized in that the package is formed by a vacuum package which is impermeable to light.

Expediently, as stated in claim 3, the package protects against UV light.

As stated in claim 4, a particularly expedient package consists of a laminate of a polyester film, an aluminium sheet and a valcros layer, with an adhesive layer interposed between the layers, which adhesive layer both has good mechanical properties and is insensitive to light.

When, as stated in claim 5, a drying means is positioned inside the package, it is advantageously ensured that any residual moisture that might occur is caught and bonded to the drying means.

When, as stated in claim 6, an inspection window is arranged on the surface of the package, it is possible to inspect the safety and rescue equipment physically.

If, as stated in claim 7, a flap is arranged in front of the inspection window, it is ensured that penetration of light to the safety and rescue equipment is eliminated.

To additionally ensure that the safety and rescue equipment is completely intact, it is advantageous if, as stated in claim 8, a moisture indicator is arranged behind the inspection window.

As mentioned, the invention also relates to a use. This use is defined in claim 9.

The invention will now be explained more fully with reference to the drawing, in which

FIG. 1 shows rescue and safety equipment for lowering a person from a tall structure,

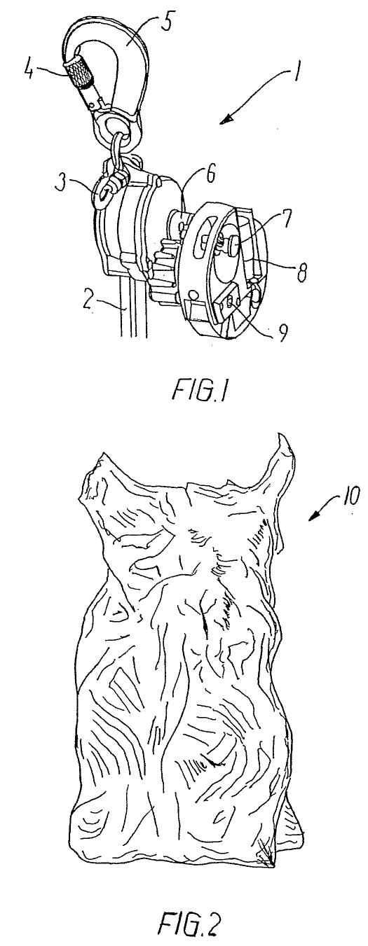

FIG. 2 shows the safety and rescue equipment in a package according to the invention,

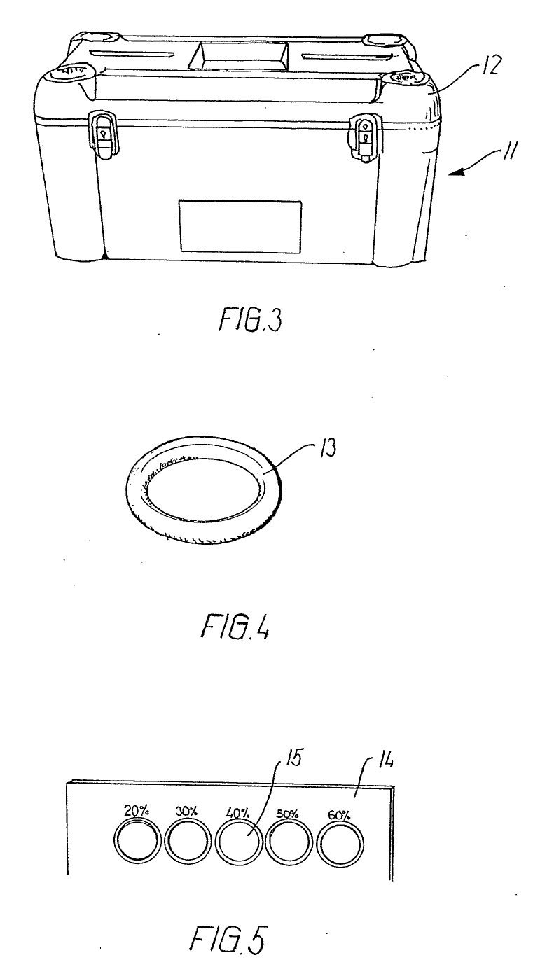

FIG. 3 shows a box for the storage of the packaged safety and rescue equipment shown in FIG. 2,

FIG. 4 shows an inspection window, while

FIG. 5 shows a moisture indicator.

In FIG. 1, the numeral 1 designates safety and rescue equipment as a whole, which is intended to be stored in tall structures, so that it may be used by persons in an emergency who need to leave the tall structure for some reason.

Typical tall structures may be windmills, drilling platforms, towers and other tall buildings, antenna masts, etc.

The actual safety and rescue equipment is of a well-known type.

As will be seen in FIG. 1, it consists of a line 2 of polyamide, a pig's tail 3, a union nut 4, a snap hook 5, a locking block 6, a locking mandrel 7, a locking ball 8 and a hand wheel 9. The parts 3-9 may be made of aluminium.

In FIG. 2, the safety and rescue equipment of FIG. 1 is packaged in a vacuum package 10. This vacuum package may consist of a laminate of a polyester film of 12 micron, an aluminium sheet of 7 micron and 200 micron valcros®, with an adhesive layer interposed between the layers.

The vacuum package is impermeable to light, including UV light, and has mechanical properties which ensure that the parts packaged in the safety and rescue equipment cannot move mutually when subjected to mechanical impacts, thereby eliminating wear between the surfaces of the parts of the equipment.

FIG. 3 shows an example of a box 11 with a lid 12 in which the vacuum-packaged safety and rescue equipment may be transported and stored.

FIG. 4 shows an example of an inspection window 13 which may be secured to the surface of the vacuum package so that the safety and rescue equipment may be inspected.

Optionally, a flap (not shown) is arranged in front of the inspection window so that penetration of light to the safety and rescue equipment is prevented.

A drying means, which protects the safety and rescue equipment against harmful moisture, may also be provided in the vacuum package itself. This drying means may e.g. be silica gel, bentonite or molecular sieven.

Finally, a moisture indicator may be provided behind the inspection window, as shown at 14 in FIG. 5. This moisture indicator operates in the way that if the moisture increases, a change of colour of the circular areas will take place in response to the moisture concentration. With a 40% moisture, the circle 15 and the two circles to the left of it will change their colour.

As will be appreciated, the invention provides a safe protection and monitoring of safety and rescue equipment, which means that the time intervals between the inspections may be increased considerably.

1. A method of packaging safety and rescue equipment consisting of individually mutually moving parts of metal and non-metal, comprising packaging all of the individually moving parts of the safety and rescue equipment inside a vacuum package which is impermeable to light and which prevents the metal and non-metal parts from moving mutually.

2. A package for packaging safety and rescue equipment consisting of individually mutually moving parts of metal and non-metal inside a vacuum package which is impermeable to light, the vacuum package preventing the metal and non-metal parts from moving mutually.

3. A package according to claim 2, wherein the package protects against UV light.

4. A package according to claim 2, wherein the package consists of a laminate of a polyester film, an aluminum sheet and a valcros layer, with an adhesive layer interposed between the layers.

5. A package according to claim 2, including drying means arranged inside the package.

6. A package according to claim 2, wherein a surface of the package includes an inspection window.

7. A package according to claim 6, including a flap arranged in front of the inspection window.

8. A package according to claim 6, including a moisture indicator arranged behind the inspection window.

9. (canceled)
